(19) United States
(12) Patent Application Publication
(10) Pub. No.: US 2023/0394522 A1
(43) Pub. Date: Dec. 7, 2023

(54) PRIVACY PRESERVING DATA SHARING FOR CAMPAIGNS USING HIERARCHICAL CAMPAIGN IDENTIFIERS

(71) Applicant: Apple Inc., Cupertino, CA (US)

(72) Inventors: John WILANDER, San Jose, CA (US); Artem KIRILLOV, Ben Lomond, CA (US); Dana J. DUBOIS, San Francisco, CA (US); Mahesh MOLAKALAPALLI, Santa Clara, CA (US); Nikhil R. VARMA, Seattle, WA (US); Zhaocheng A. Tan, Cupertino, CA (US)

(21) Appl. No.: 18/109,241

(22) Filed: Feb. 13, 2023

Related U.S. Application Data
(60) Provisional application No. 63/349,038, filed on Jun. 3, 2022.

(51) Int. Cl. G06Q 30/0242

(52) U.S. Cl. CPC G06Q 30/0243; G06Q 30/0246

(57) ABSTRACT

Aspects of the subject technology receiving, by a campaign client module and via an advertisement network server, a hierarchical campaign identifier including one or more sub-identifiers. The campaign client module also accesses, from an aggregation server, anonymity data. The campaign client module also selects a sub-identifier from the one or more sub-identifiers of the hierarchical campaign identifier based on the anonymity data, generates a reporting data structure including a set of data based on the sub-identifier, and transmits the reporting data structure to the advertisement network server.

### CROSS-REFERENCE TO RELATED APPLICATIONS

The present application claims the benefit of U.S. Provisional Patent Application Ser. No. 63/349,038, entitled “PRIVACY PRESERVING DATA SHARING FOR CAMPAIGNS USING HIERARCHICAL CAMPAIGN IDENTIFIERS,” filed Jun. 3, 2022, which is hereby incorporated herein by reference in its entirety and made part of the present U.S. Utility Patent Application for all purposes.

### TECHNICAL FIELD

The present description generally relates to advertisement campaigns on electronic devices and, more particularly, to privacy preserving data sharing for campaigns using hierarchical campaign identifiers.

### BACKGROUND

An electronic device such as a laptop, tablet, or smartphone, may be configured to participate in advertisement campaigns for presenting advertisements to users. An advertiser responsible for an advertisement campaign may like to receive information regarding the performance of their advertisement campaign and the efficacy of advertisements across different segments of users.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment in which a device may interact with an advertisement network server and an aggregation server, in accordance with one or more implementations.

FIG. 2 depicts an example electronic device that may implement the subject methods and systems, in accordance with one or more implementations.

FIG. 3 depicts a schematic diagram of an example advertisement conversion, in accordance with one or more implementations.

FIG. 4 depicts a schematic diagram of an example sequence of a campaign client module generating a reporting data structure, in accordance with one or more implementations.

FIG. 5 depicts a schematic diagram of an example sequence of an advertisement network server sending a hierarchical campaign identifier and receiving a corresponding sub-identifier, in accordance with one or more implementations.

FIG. 6 depicts a diagram of an example crowd anonymity function for selecting a sub-identifier from a hierarchical campaign identifier, in accordance with one or more implementations.

FIG. 7 depicts a flow diagram of an example process for generating a reporting data structure by a campaign client module, in accordance with one or more implementations.

FIG. 8 depicts a flow diagram of an example process for generating a reporting data structure by a campaign client module with a sub-identifier selected by the aggregation server, in accordance with one or more implementations.

FIG. 9 depicts a flow diagram of an example process for requesting advertisement campaign metrics by an advertisement network server, in accordance with one or more implementations.

FIG. 10 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

An advertisement framework can provide an API that enables validated attribution of advertiser-driven application installations. Installation validation informs an advertisement network when users install, re-install, and/or launch an application purchased after viewing (or performing any other impression) an advertisement for the application. Advertisement networks may initiate validation by providing information, including a campaign identifier, when displaying the advertisement for the application. If the advertisement results in a conversion (e.g., a purchase of an application), the advertisement network may be notified with a postback (or other notification) that includes the same campaign identifier. The advertisement network can then provide advertisers with metrics on advertisement conversions to enable the advertisers to track the success of the advertisement campaign.

In one or more implementations of the subject system, the advertisement framework may support a hierarchical campaign identifier that can be used in place of a traditional campaign identifier for a given advertising campaign. The hierarchical campaign identifier can specify related sub-identifiers that correspond to different levels of user demographic granularity (e.g., low, medium, and high). If the advertisement results in a conversion on a user device, a campaign client module on the user device may notify the advertisement network with a reporting data structure (e.g., a postback) that is based on one of the sub-identifiers corresponding to the hierarchical campaign identifier included in the request. The subject system may determine, such as based on how many conversions have previously occurred for the given advertisement, the highest level of user demographic granularity that can be provided while still maintaining user privacy. In this manner, the advertisement network is provided with the most granular user demographic information that can be provided while still maintaining user privacy.

Accordingly, implementations of the subject technology described herein provide techniques to enable privacy preserving data sharing for campaigns. Relevant campaigns include advertisement campaigns facilitated via a content delivery network (e.g., an advertising network).

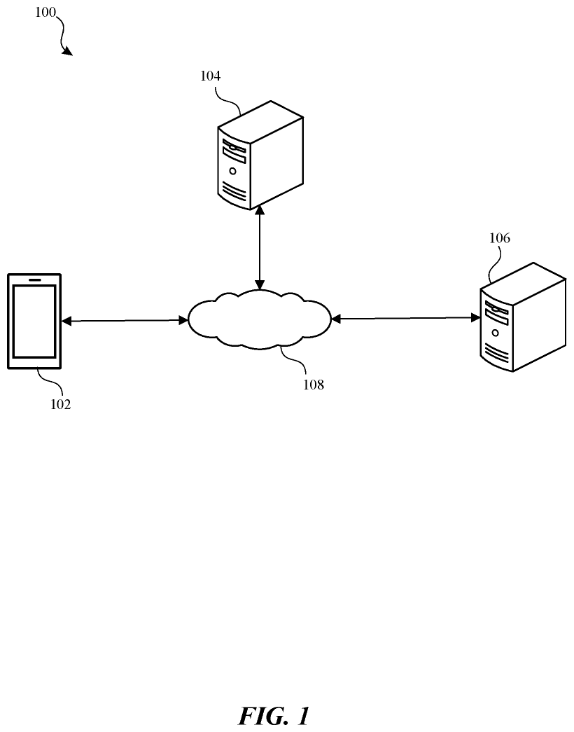

FIG. 1 illustrates an example network environment in which a device may interact with an advertisement network server and an aggregation server, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an advertisement network server 104, and an aggregation server 106. The network 108 may communicatively (directly or indirectly) couple the electronic device 102, the advertisement network server 104, and/or the aggregation server 106. In one or more implementations, the network 108 may be an interconnected network of devices that may include, or may be communicatively coupled to, the Internet. For explanatory purposes, the network environment 100 is illustrated in FIG. 1 as including electronic device 102, the advertisement network server 104, and/or the aggregation server 106; however, the network environment 100 may include any number of electronic devices and/or any number of servers communicatively coupled to each other directly or via the network 108.

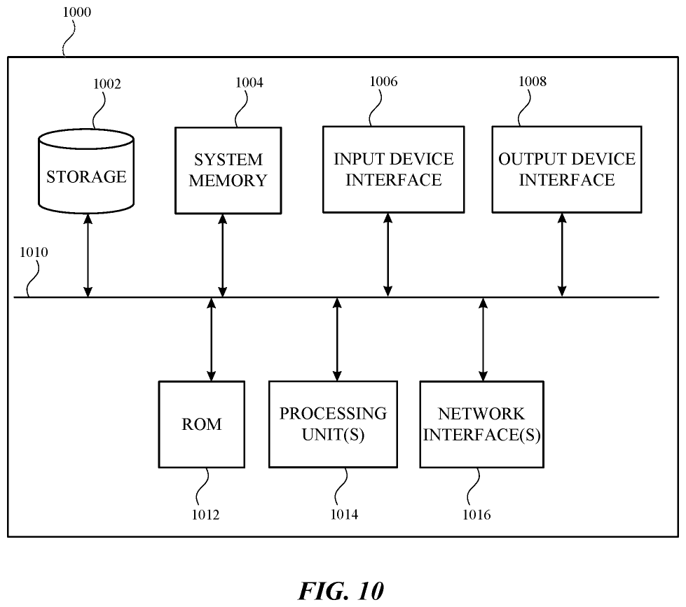

The electronic device 102 may be, for example, a desktop computer, a portable computing device such as a laptop computer, a smartphone, a peripheral device (e.g., a digital camera, headphones), a tablet device, a wearable device (e.g., a watch, a band, and the like), or any other appropriate device that includes, for example, one or more wireless interfaces, such as WLAN radios, cellular radios, Bluetooth radios, Zigbee radios, near field communication (NFC) radios, and/or other wireless radios. In one or more implementations, the electronic device 102 may include a campaign client module (and/or circuitry) and one or more applications capable of presenting advertisements. In FIG. 1, by way of example, the electronic device 102 is depicted as a smartphone. The electronic device 102 may be, and/or may include all or part of, the electronic system discussed below with respect to FIG. 10. In one or more implementations, the electronic device 102 may include a touchscreen and may present advertisements to a user and receive impressions from a user with respect to the advertisements, such as clicks, conversions, views, and/or other engagements.

The advertisement network server 104 may be, for example, a desktop computer, a server computer, a portable computer, or any other appropriate device that includes, for example, one or more networking interfaces. The advertisement network server 104 may perform operations for managing an advertisement campaign that may be running on one or more electronic devices, such as the electronic device 102. Managing the advertisement campaign may include receiving performance metrics (e.g., conversion data) of the advertisement campaign from devices running the advertisement campaign. In some variations, the advertisement network server 104 includes one or more modules for sending and/or receiving data asynchronously to one or more electronic devices (e.g., publish-subscribe messaging). In one or more implementations, the advertisement network server 104 may provide content (e.g., media content, application content, or any other suitable data) that is to be processed at a participant device (e.g., the electronic device 102) by an application or operating system of the participant device.

The aggregation server 106 may be, for example, a desktop computer, a server computer, a portable computer, or any other appropriate device that includes, for example, one or more networking interfaces. The aggregation server 106 may perform operations for determining a level of anonymity (e.g., by processing an anonymity function) for electronic devices associated with the aggregation server 106, an advertisement campaign, an application, and/or other common characteristics. In some variations, the aggregation server 106 includes one or more modules for sending and/or receiving data asynchronously to one or more electronic devices (e.g., publish-subscribe messaging). In one or more implementations, the aggregation server 106 may determine the number of non-unique combinations of data associated with a set of conversions for an advertisement campaign. In one or more implementations, the aggregation server 106 may determine an appropriate sub-identifier of a hierarchical campaign identifier based on a determined level of anonymity of the device corresponding to the hierarchical campaign identifier.

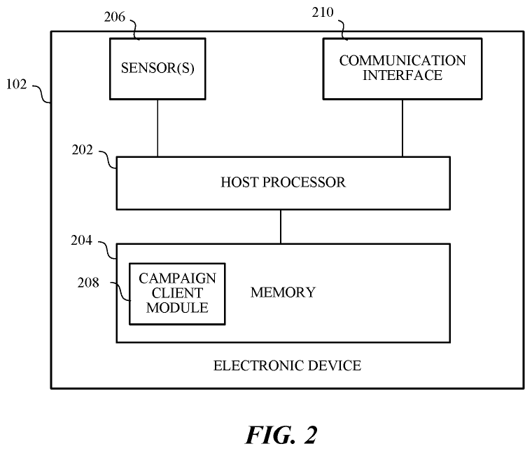

FIG. 2 depicts an electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, a campaign client module 208, one or more sensor(s) 206, and/or a communication interface 210. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage. In one or more implementations, the memory 204 may store advertisement campaign data (e.g., as provided by the advertisement network server 104) for participating in an advertisement campaign. The memory 204 may further store account information and any other type of identifier that associates the electronic device 102 with its corresponding user account and/or applications.

The sensor(s) 206 may include a touchscreen, microphone, and/or camera. The touchscreen may be used to present advertisements from an advertisement campaign and/or receive user interactions (e.g., views or clicks) for generating advertisement impressions and/or conversions. The microphones and/or cameras may be similarly used to facilitate advertisement interactions.

The campaign client module 208 may be one or more modules for facilitating the use of hierarchical campaign identifiers. Facilitating a hierarchical campaign identifier may include collecting advertisement campaign metrics (e.g., conversion values, anonymity metrics, and/or the like), generating reporting data structures (e.g., postbacks), and/or any other advertisement-campaign-related activity.

The communication interface 210 may include suitable logic, circuitry, and/or code that enables wired or wireless communication, such as between the electronic device 102 and the advertisement network server 104. The communication interface 210 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the sensor(s) 206, the campaign client module 208, the communication interface 210, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

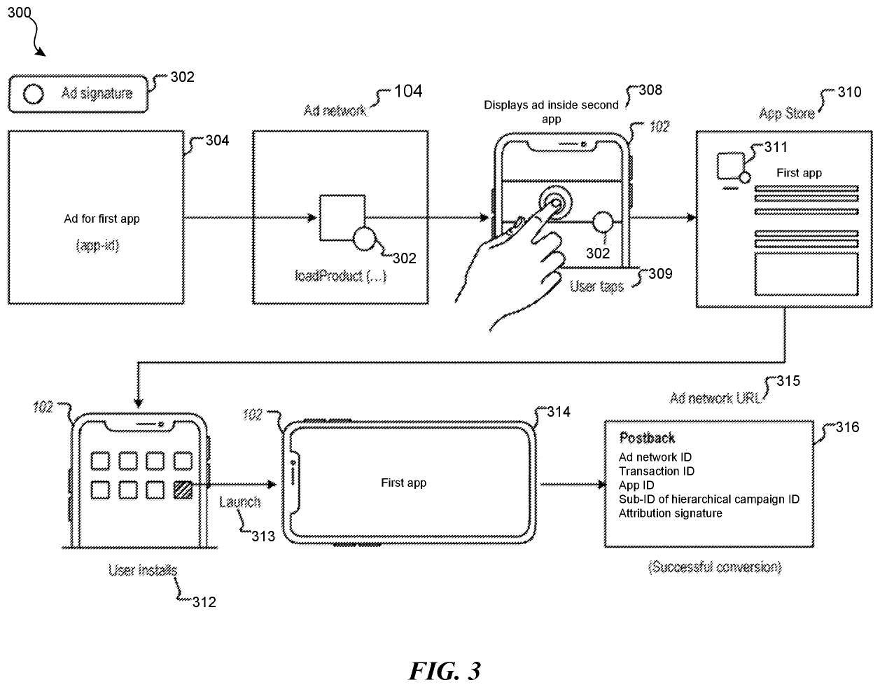

FIG. 3 depicts a schematic diagram of an example advertisement conversion 300, in accordance with one or more implementations. An advertisement network API may help advertisers (e.g., developers) measure the success of an advertisement campaign while maintaining user privacy. Applications can participate in an advertisement campaign by displaying advertisements served by an advertisement network server 104. When a user taps an advertisement displayed on an electronic device 102, a product screen may be displayed that provides the user with the ability to purchase and install (or redownload, if previously purchased) the advertised application (e.g., a first application). If the user installs and opens the first application, the campaign client module can send a reporting data structure (e.g., conversion notification) for that advertisement campaign to the advertisement network server 104 that identifies the advertisement campaign, a sub-identifier of a hierarchical campaign identifier, a conversion value, the installed application associated with the conversion, and the like. In one or more implementations, the electronic device 102 can store the parameters of the reporting data structure for the advertised application for a period of time, which can be replaced by the most recent version provided. The conversion notification may be signed by the campaign client module and does not include user-specific or device-specific data.

In one or more implementations, an advertisement signature 302 may be embedded in an advertisement 304 (e.g., a digital advertisement data object) to enable the identification of the advertisement campaign with which the advertisement 304 is associated and a corresponding hierarchical campaign identifier. The advertisement 304 can be for a first application that can be purchased and/or downloaded, such as from an application store. The advertisement 304 can have an application identifier that identifies the application that is being advertised. A content delivery network, such as an advertisement network (e.g., run by advertisement network server 104), can facilitate the delivery of advertisements, such as for an advertisement campaign. Connections to the advertisement network server 104 can be established, such as by the electronic device 102, directly or indirectly (e.g., via a proxy server). The advertisement network server 104 can deliver the advertisement 304 with the advertisement signature 302. An electronic device 102 can execute a second application that is registered with the advertisement network server 104 to display advertisements inside the application (308). An advertisement 304 for the first application can be displayed via a user interface (UI) of the second application. When a user taps (309) the advertisement 304 for the first application that is displayed in the second application, the application identifier included in the advertisement 304 enables a UI for the application store 310 to be loaded, and/or for the first application to be otherwise downloaded and/or installed. The UI for the application store 310 can include a UI element 311 that enables the purchase and/or download of the first application.

A user can install (312) the first application on the electronic device 102. Upon request from the user, the electronic device 102 can perform a launch operation (313) for the first application. In one or more implementations, the user may not click on the advertisement 304 but may install the first application after viewing the advertisement 304 (e.g., within some threshold amount of time of viewing the advertisement 304). After the launch of the installed first application (313), a UI 314 for the first application can be displayed. Upon first launch of the first application, or after the expiration of a timer, a campaign client module 208 on the electronic device 102 can send a reporting data structure 316 to the advertisement network server 104 using an advertisement network URL 315. The advertisement network URL 315 may be provided via the advertisement signature 302 and can be captured when the user taps (309) the advertisement 304, and/or when the advertisement 304 is presented to the user. The campaign client module 208 of the electronic device 102 may send the reporting data structure 316 independent of both the first application and the second application. Accordingly, program code that executes in either the first application or the second application may be unaware of when the reporting data structure 316 is transmitted to the advertisement network server 104.

The reporting data structure 316 may include, but is not limited to, an advertisement network identifier that identifies the advertisement network server 104, a transaction identifier for the reporting data structure 316, the application identifier that identifies the app that was advertised and/or purchased, a sub-identifier of the hierarchical campaign identifier that corresponds to user demographic data and is selected based on user anonymity, and an attribution signature that attests to the validity of the conversion attribution. However, the reporting data structure 316 does not include user-level data that identifies a user associated with the conversion.

As it may be beneficial to advertisers and/or the advertisement network server 104 to gather as much information as possible about the advertisement conversion 300, the program code that executes in the first and/or second applications may attempt to gather data about the advertisement conversion that can be transmitted to the advertisement network server 104. Correlation logic on those servers may analyze the data to extract information about the conversion that may be useful for marketing purposes, potentially at the expense of the privacy of the user.

To mitigate potential privacy risks, the information that is presented via the reporting data structure 316 is limited to prevent this correlation. The information may be limited such that the information that may be derived from the reporting data structure 316 is reduced when the electronic device 102 is less anonymous (e.g., with respect to a population of devices having the first application) and may be increased when the electronic device 102 is more anonymous.

For example, one or more identifiers may be transmitted within the reporting data structure 316. These one or more identifiers from the reporting data structure can be used by the advertisement network server 104 to generate metrics for the advertisement campaign. However, when a low number of conversions have occurred for an advertisement campaign, one or more identifiers may be used by the advertisement network server 104 to tie the reporting data structure 316 with specific instances of the first or second application. If specific instances of the first or second application may be determined, the advertisement network server 104 may be able to determine the identity, or other information, of a specific user. Accordingly, the transmission of the one or more identifiers within the reporting data structure 316 may be limited until a sufficient number of conversions have occurred. Once a threshold number of conversions have occurred, the transmission of the one or more identifiers within the reporting data structure 316 may be less limited. In one or more implementations, the reporting data structure 316 may be transmitted without any identifiers if a threshold number of conversions have not yet occurred.

In the reporting data structure 316, conversion values may also be provided to the advertisement network server 104. The conversion values can include metrics about the activity that the user has performed in the first application. The conversion value may be encoded in an n-bit number which may be used by the developer of the first application or the advertisement network server 104 to encode any information about activity in the first application. The conversion value can represent, for example, activity performed by the user after installation, user retention data, and/or data that can be used to rate a return on investment on the advertisement campaign. Implementations described herein provide techniques to limit when or how much conversion data is transmitted within the reporting data structure 316 to limit the ability of the advertisement network server 104 to use the conversion values to link the conversion to a specific user. The hierarchical campaign identifier may also correspond to one or more tiers of conversion values (e.g., coarse or fine values). The conversion values may be limited such that the conversion values that may be derived from the reporting data structure 316 reflect a more general (e.g., reduced) set of conversion actions (e.g., coarse values) when the electronic device 102 is less anonymous (e.g., with respect to a population of devices having the first application) and reflect a more specific (e.g., extensive) set of conversion actions when the electronic device 102 is more anonymous.

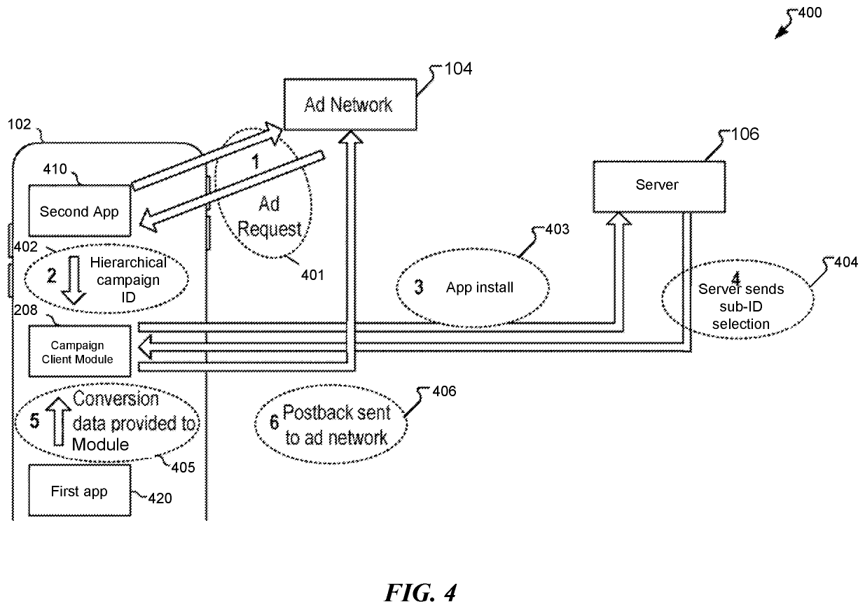

FIG. 4 depicts a schematic diagram of an example sequence 400 of a campaign client module 208 generating a reporting data structure (e.g., a postback), in accordance with one or more implementations. The electronic device 102 may have a first application 420 and a second application 410. The second application 410 may execute on the electronic device 102 which may be registered with the advertisement network server 104 and can send (401) an advertisement request to the advertisement network server 104. In response to the advertisement request, the advertisement network server 104 may reference one or more data categories from a list of predefined data categories that correspond to one or more sub-identifiers, where each sub-identifier corresponds to a different number of data categories defining different levels of specificity. For example, one sub-identifier may correspond to five data categories, which is more specific than a sub-identifier that only corresponds to two data categories. The sub-identifiers may be combined to form a hierarchical campaign identifier. In one or more implementations, the hierarchical campaign identifier is limited to a specified number of sub-identifiers (e.g., three sub-identifiers). The hierarchical campaign identifier and an advertisement may correspond to an advertisement campaign specifying particular values for the data categories corresponding to one or more of the sub-identifiers. The hierarchical campaign identifier and the advertisement may be served to devices (e.g., the electronic device 102) in the demographic corresponding to the specified values for the data categories of the one or more sub-identifiers.

The second application 410 may interface with APIs that enable the application to receive the advertisement via the advertisement network server 104. The second application 410 and the advertisement network server 104 may be different parties. In response to the request, an advertisement (e.g., the advertisement 304) can be provided to the second application 410. The advertisement can be associated with an advertisement campaign that is associated with, for example, a developer for the first application 420 as well as a hierarchical campaign identifier associated with the advertisement campaign. The hierarchical campaign identifier may be transmitted (402) to the campaign client module 208 to help the campaign client module 208 determine what data to place in the reporting data structure (e.g., the reporting data structure 316).

Because the hierarchical campaign identifier contains one or more sub-identifiers that correspond to different levels of data, the campaign client module 208 may determine or receive a selection of a sub-identifier. The selection or determination may occur when the user requests to download, purchase, or redownload/re-install (403) the first application. A redownload can be performed if the user has previously purchased and/or installed the application but the application is not currently installed on the electronic device 102. When the user requests to install or redownload (403) the first application, the campaign client module 208 may access anonymity data from the aggregation server 106 for determining the anonymity of the electronic device 102 with respect to other devices associated with the aggregation server 106, the first application 420, and/or the second application 410. The aggregation server 106 may provide (and, in some implementations, sign) (404) the anonymity data. Additionally or alternatively, the aggregation server 106 performs an anonymity function calculation for determining a level of anonymity corresponding to a sub-identifier of the hierarchical campaign identifier. Additionally or alternatively, the aggregation server 106 may select the appropriate sub-identifier from the hierarchical campaign identifier.

Selecting a sub-identifier of the hierarchical campaign identifier (e.g., by processing a crowd anonymity function) is performed to limit the information that is provided to the advertisement network server 104 based on the number of advertisement conversions or other interactions performed with respect to the advertisement and/or corresponding campaign. As more non-unique interactions are performed with the advertisement and/or advertising campaign, additional information may be provided to the advertisement network server 104 without enabling the linking of the identities of the users associated with the conversions. For example, the aggregation server 106 may maintain a count such that a counter is incremented each time the first application 420 is purchased and/or downloaded as a result of an advertisement campaign, which can then be used to determine the amount of crowd anonymity present. As the counter increases, the anonymity of the electronic device 102 (e.g., with respect to the first application 420) may increase and a more specific sub-identifier of the hierarchical campaign identifier may be provided in the reporting data structure.

After launch or re-launch (after a re-install), the first application 420 can provide (405) conversion data to the campaign client module. The conversion data may be a set of values corresponding to actions with the first application 420 specified by the developer of the first application 420. This value may be continually updated as the user performs actions, such as advancing in a game application, performing in-app purchases, sharing applications, providing app reviews or comments, or other similar interactions. The conversion values may also include multiple levels corresponding to the level of anonymity of the electronic device 102 (e.g., with respect to the first application 420). For example, the first application 420 may be programmed to have a set of coarse values for conversions that correspond to, for example, up to four types of interactions and a set of fine values that correspond to, for example, up to 64 types of interactions, where the fine values may be used if the anonymity of the electronic device 102 exceeds a threshold value; otherwise, the coarse values may be used.

A reporting data structure may be generated by the campaign client module 208 and includes a set of data based on the anonymity such as the sub-identifier and conversion values. The reporting data structure (e.g., a postback) may be sent (406) to the advertisement network server 104 for the advertiser to update advertisement campaign metrics corresponding to the advertisement campaign for determining the performance of the advertisement campaign.

The data sharing for advertisement campaigns that is described herein is performed in a privacy-preserving manner by limiting the ability of the advertisement network server 104 to determine specific non-anonymized information about the user. For example, privacy-preserving techniques are applied to prevent data that is provided via the reporting data structure to the advertisement network server 104 to enable the advertisement network server 104 to tie the advertisement and/or conversions to specific instances of the first application 420 or the second application 410.

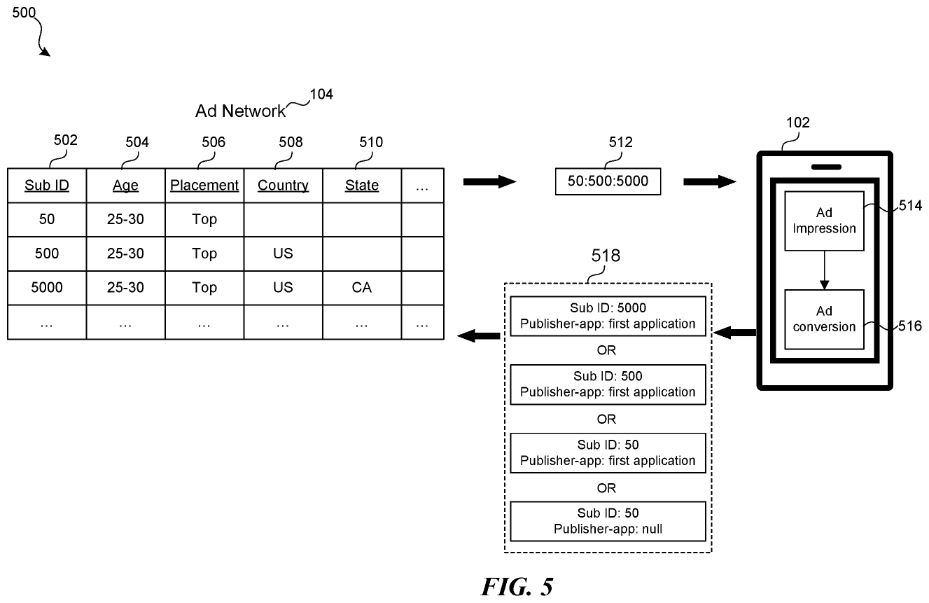

FIG. 5 depicts a schematic diagram of an example sequence 500 of an advertisement network server 104 sending a hierarchical campaign identifier 512 and receiving a sub-identifier 518 of the hierarchical campaign identifier 512, in accordance with one or more implementations. The hierarchical campaign identifier 512 may correspond to an advertisement campaign and include one or more sub-identifiers (e.g., 50, 500, and 5000) for receiving data at various levels of granularity. Generating the hierarchical campaign identifier 512 may include generating campaign information for one or more of the sub-identifiers of the hierarchical campaign identifier, where the campaign information corresponds to one or more data categories from a list of predefined data categories (e.g., age 504, placement 506, country 508, and state 510). The data categories may be defined by a developer in the programming of the advertisement campaign of the advertisement network server 104 and/or the programming of the advertised application (e.g., the first application 420).

The hierarchical campaign identifier 512 may be transmitted to the electronic device 102, and the hierarchical campaign identifier may be embedded in a digital advertisement data object, which may include an advertisement signature (e.g., the advertisement signature 302). The digital advertisement data object may be and/or may include an advertisement (e.g., the advertisement 304) for a first application. The advertisement may be presented on a second application (e.g., the second application 410). When a user taps the advertisement that is displayed in the second application as an advertisement impression 514, the application identifier included in the advertisement enables a UI for the purchase and/or download of the first application as an advertisement conversion 516.

After advertisement conversion 516 and/or periodically, the campaign client module (e.g., the campaign client module 208) of the electronic device 102 may provide data, such as conversion data, to the advertisement network server 104. The data may be provided in the form of a reporting data structure (e.g., the reporting data structure 316). The set of data included in the reporting data structure may correspond to and/or include a sub-identifier 518 from the hierarchical campaign identifier 512. For example, the reporting data structure 316 may include a sub-identifier of the hierarchical campaign identifier.

The sub-identifier 518 may be identified by receiving or selecting a sub-identifier of the hierarchical campaign identifier 512 (e.g., from the aggregation server 106 or the campaign client module 208) based on an anonymity function. The sub-identifier 518 may be selected by identifying one or more anonymity thresholds corresponding to one or more sub-identifiers. With the identified anonymity thresholds, the aggregation server may determine whether the anonymity data indicates anonymity exceeding one or more of the identified anonymity thresholds. As more identified anonymity thresholds are exceeded, the sub-identifier 518 returned may be more specific. Accordingly, the sub-identifier 518 corresponding to the most data and exceeding an identified anonymity threshold may be selected. In one or more implementations, the reported sub-identifier may be set to “null” until a threshold number of conversions have occurred. When the sub-identifier 518 is received by the advertisement network server 104, the advertisement network server 104 may update an advertisement campaign metric according to the data categories and/or data values of the data categories corresponding to the sub-identifier 518 received. For example, if sub-identifier “5000” is received, the advertisement network server may increment a counter for the data categories age 504, placement 506, country 508, and state 510, having values 25-30, top, US, and CA, respectively. In some implementations, additional information may be provided by the reporting data structures, such as the publisher app of the advertisement, and store metrics relating to the sub-identifier and the publisher app (e.g., the frequency of the sub-identifier appearing with a particular publisher app).

The aggregation server may track, for example, how many times the sub-identifier of “50” (and/or other double-digit sub-identifiers) has been reported back to the advertisement network server for the given advertisement, how many times the sub-identifier of “500” (and/or other triple-digit sub-identifiers) has been reported back to the advertisement network server, and how many times the sub-identifier “5000” (and/or other four-digit sub-identifiers) has been reported back to the advertisement network server. Based on the number of times the various sub-identifiers have been reported back to the advertisement network server, the aggregation server can determine an approximate anonymity associated with transmitting any subsequent sub-identifier to the advertisement network server.

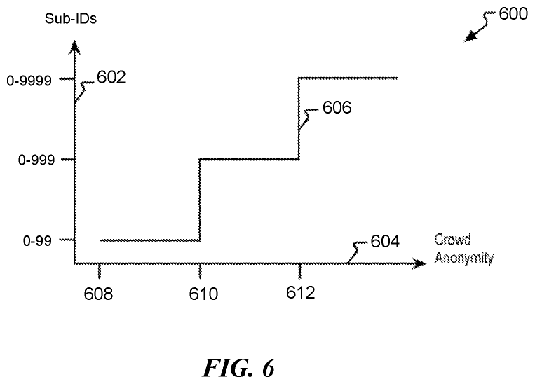

FIG. 6 depicts a diagram of an example anonymity function 600 for selecting a sub-identifier (e.g., axis 602) from a hierarchical campaign identifier, in accordance with one or more implementations. The reporting data structure can include a sub-identifier of a hierarchical campaign identifier as well as conversion values of one or more conversion operations associated with an application, where the conversion values may be a coarse conversion value and/or a fine conversion value based on the sub-identifier. The number of data categories or the level of conversion values that are included in the reporting data structure is based on anonymity calculated by the anonymity function 600 so that the data included in the reporting data structure will not potentially leak the identity of the user associated with the reporting data structure.

The anonymity function 600 may be a function of variables including the number of devices that have purchased and/or installed or redownloaded the advertised application, a number of non-unique impressions on the advertisement campaign corresponding to the advertised application, the number of times a conversion value is sent relating to the advertised application, the number of reporting data structures sent relating to the advertised application, and/or the like. The anonymity function 600 is processed by the aggregation server (e.g., the aggregation server 106) to select a sub-identifier of the hierarchical campaign identifier. The sub-identifier that may be selected is the sub-identifier with the most specificity corresponding to the greatest amount of anonymity. The aggregation server may send the selection for the client campaign module of the electronic device to use for the reporting data structures.

Axis 602 illustrates the selection of sub-identifiers from hierarchical campaign identifiers. Axis 604 illustrates anonymity thresholds associated with an advertisement campaign. For example, the axis 604 may have a low threshold 608, a medium threshold 610, and a high threshold 612. The anonymity function 600 may determine the number of non-unique interactions performed in association with an advertisement campaign. A high threshold 612 for an advertisement campaign correlates with a low likelihood that a reporting data structure for a reported conversion can be used to link a specific user to both legs (e.g., the advertised application and the advertising application) of a conversion. For each of these legs, an independent calculation may be performed to determine if the data is unique and can be used by the advertisement network server 104 to identify the user. As data becomes less unique, more data elements may be included within a reporting data structure (e.g., as opposed to a “null” value). As the anonymity value increases, the specificity of the sub-identifier (606) that is sent increases.

For example, a hierarchical campaign identifier may include three tiers of sub-identifiers, each tier increasing in specificity: 0-99, 0-999, and 0-9999. The increase in numbers in each tier allows developers to have more sub-identifiers to correlate to more combinations of data categories, and thus receive more granular data if anonymity allows. A particular hierarchical campaign identifier may include a number from each tier (e.g., 10, 100, and 1000). If the anonymity level of the advertised application is beyond a high threshold 612, the sub-identifier specified in the hierarchical campaign identifier that is the most specific (e.g., sub-identifier 5000 in hierarchical campaign identifier 512) may be sent to the advertisement network server via the reporting data structure. If the anonymity level of the advertised application is beyond a medium threshold 610, the sub-identifier specified in the hierarchical campaign identifier that is at a medium level of specificity (e.g., sub-identifier “500” in hierarchical campaign identifier 512) may be sent to the advertisement network server via the reporting data structure. If the anonymity level of the advertised application does not pass any anonymity threshold, the sub-identifier specified in the hierarchical campaign identifier that is at a low level of specificity (e.g., sub-identifier 50 in hierarchical campaign identifier 512) may be sent to the advertisement network server via the reporting data structure. The advertiser may program the advertisement campaign to correspond a sub-identifier to one or more data categories and/or one or more data values corresponding to each respective data category. Exemplary data categories may include age 504, placement 506, country 508, state 510, or other information.

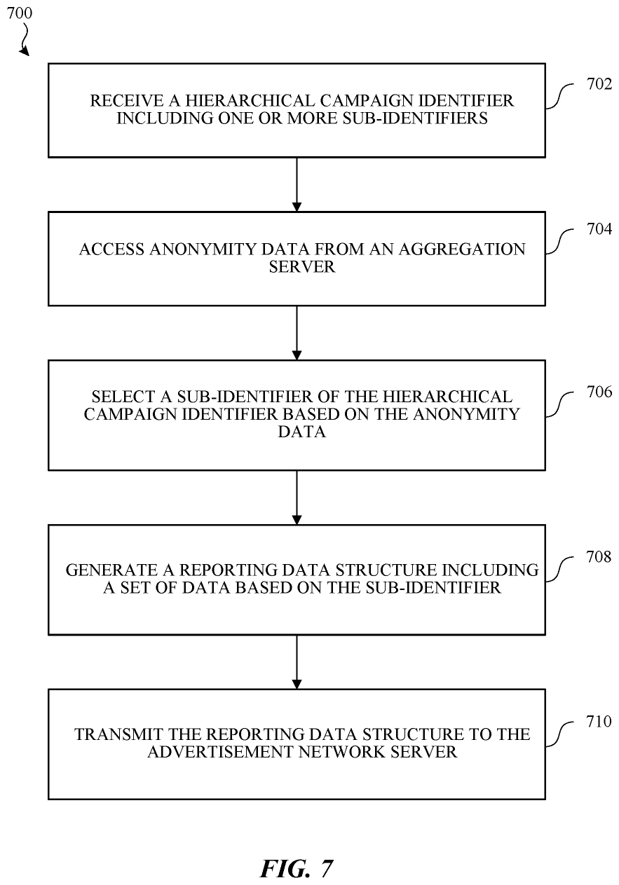

FIG. 7 depicts a flow diagram of an example process 700 for generating a reporting data structure (e.g., the reporting data structure 316) by a campaign client module (e.g., the campaign client module 208), in accordance with one or more implementations. For explanatory purposes, the process 700 is primarily described herein with reference to the electronic device 102, the advertisement network server 104, and the aggregation server 106 of FIGS. 1 and 4. However, the process 700 is not limited to the electronic device 102, the advertisement network server 104, and/or the aggregation server 106, and one or more blocks (also referred to as operations) of the process 700 may be performed by one or more other components of the electronic device 102, and/or by other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, a hierarchical campaign identifier may be received by a campaign client module (e.g., campaign client module 208) via an advertisement network server (e.g., advertisement network server 104). The hierarchical campaign identifier includes one or more sub-identifiers corresponding to different levels of anonymity. In one or more implementations, the hierarchical campaign identifier is received in response to a request to purchase, redownload, and/or install a first application (e.g., the first application 420) subsequent to the presentation of an advertisement in association with a second application (e.g., the second application 410).

At block 704, anonymity data may be accessed from the aggregation server (e.g., the aggregation server 106). The anonymity data may be accessed by the campaign client module to determine the level of anonymity of the campaign client module with respect to the advertisement network server 104, an advertisement campaign, the first application, and/or the second application. The anonymity data may be based on anonymity metrics of a plurality of campaign client modules (or corresponding devices) associated with the aggregation server and an application (e.g., the first application and/or the second application).

At block 706, a sub-identifier from the one or more sub-identifiers of the hierarchical campaign identifier may be selected based on the anonymity data. Selecting the sub-identifier may include identifying one or more anonymity thresholds corresponding to one or more sub-identifiers. For example, a hierarchical campaign identifier may include three sub-identifiers representing a low, medium, and high anonymity threshold (e.g., threshold 608, threshold 610, and threshold 612, respectively). With the identified anonymity thresholds, the campaign client module may determine whether the anonymity data indicates that anonymity exceeds one or more of the identified anonymity thresholds. As more identified anonymity thresholds are exceeded, more specific information (e.g., more granular sub-identifiers and conversion values) may be included in the reporting data structure. Accordingly, the campaign client module may select the sub-identifier corresponding to the most data that still exceeds the corresponding anonymity threshold.

For example, referring to FIG. 6, if the threshold 608, threshold 610, and threshold 612 were all exceeded by the anonymity data, the campaign client module may choose the sub-identifier corresponding to the threshold 612 because it can correspond to the most data (e.g., age 504, placement 506, country 508, and state 510).

At block 708, a reporting data structure (e.g., reporting data structure 316) is generated. The reporting data structure may correspond to an advertisement for a first application (e.g., the first application 420) presented in association with a second application (e.g., the second application 410). Accordingly, the reporting data structure may include an application identifier corresponding to the first application and/or the second application, based on the anonymity data.

The reporting data structure may also include a set of data based on the selected sub-identifier. The set of data may include the sub-identifier from the hierarchical campaign identifier selected based on an anonymity function processed by the aggregation server. The set of data may also include a conversion value of a conversion operation associated with an application (e.g., the first application 420). The conversion operation may be an operation from a list of predefined operations associated with one or more conversion values, as defined by the developer of the application. The one or more conversion values may be a coarse conversion value and/or a fine conversion value, where coarse conversion values correspond to fewer conversion operations and lower anonymity and the fine conversion values correspond to more conversion operations and higher anonymity.

At block 710, the reporting data structure may be transmitted to the advertisement network server (e.g., the advertisement network server 104). The reporting data structure may be transmitted via a network (e.g., the network 108). The reporting data structure may be sent to the advertisement network server directly or indirectly. The advertisement network server may identify one or more data categories from a list of predefined data categories based on the selected sub-identifier and update one or more metrics (e.g., counters) associated with the identified data categories. For example, referring to FIG. 5, the data categories may include age 504, placement 506, country 508, and state 510, if the selected sub-identifier 502 is 5000, for which the advertiser has assigned the data values 25-30, top, US, and CA, respectively.

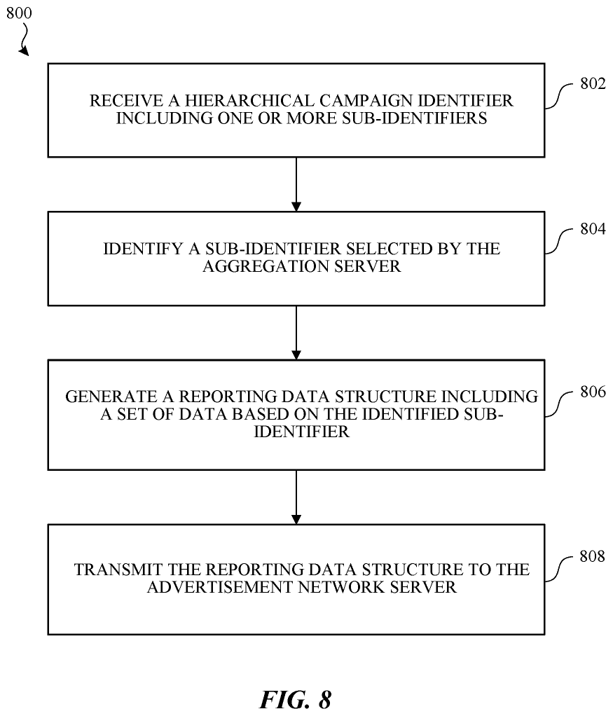

FIG. 8 depicts a flow diagram of an example process 800 for generating a reporting data structure by a campaign client module with a sub-identifier selected by the aggregation server, in accordance with one or more implementations. For explanatory purposes, the process 800 is primarily described herein with reference to the electronic device 102, the advertisement network server 104, and the aggregation server 106 of FIGS. 1 and 4. However, the process 800 is not limited to the electronic device 102, the advertisement network server 104, and/or the aggregation server 106, and one or more blocks (also referred to as operations) of the process 800 may be performed by one or more other components of the electronic device 102, and/or by other suitable devices. Further, for explanatory purposes, the blocks of the process 800 are described herein as occurring sequentially or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, a hierarchical campaign identifier (e.g., the hierarchical campaign identifier 512) may be received by a campaign client module (e.g., campaign client module 208) via an advertisement network server (e.g., advertisement network server 104). The hierarchical campaign identifier includes one or more sub-identifiers corresponding to different levels of anonymity. In one or more implementations, the hierarchical campaign identifier is received in response to at least one of a request to purchase, redownload, or install a first application (e.g., the first application 420) subsequent to the presentation of an advertisement in association with a second application (e.g., the second application 410).

At block 804, a sub-identifier selected by the aggregation server (e.g., the aggregation server 106) may be identified by the campaign client module. The sub-identifier may be identified by receiving a sub-identifier of the hierarchical campaign identifier from the aggregation server 106 that performed an anonymity function (e.g., the anonymity function 600) for selecting the sub-identifier. The aggregation server 106 may select the sub-identifier by identifying one or more anonymity thresholds corresponding to one or more sub-identifiers. For example, a hierarchical campaign identifier may include three sub-identifiers representing a low, medium, and high anonymity threshold (e.g., threshold 608, threshold 610, and threshold 612, respectively). With the identified anonymity thresholds, the aggregation server may determine whether the anonymity data indicates anonymity exceeding one or more of the identified anonymity thresholds. As more identified anonymity thresholds are exceeded, sub-identifiers corresponding to more data may be included in the reporting data structure. Accordingly, the aggregation server 106 may select the sub-identifier corresponding to the most data and exceed an identified anonymity threshold.

At block 806, a reporting data structure (e.g., reporting data structure 316) is generated. The reporting data structure may correspond to an advertisement for a first application (e.g., the first application 420) presented in association with a second application (e.g., the second application 410). Accordingly, the reporting data structure may include an application identifier corresponding to the first application and/or the second application, based on the anonymity data.

The reporting data structure may also include a set of data based on the selected sub-identifier. The set of data may include the sub-identifier from the hierarchical campaign identifier selected based on an anonymity function processed by the aggregation server. The set of data may also include a conversion value of a conversion operation associated with an application (e.g., the first application 420). The conversion operation may be an operation from a list of predefined operations associated with one or more conversion values, as defined by the developer of the application. The one or more conversion values may be a coarse conversion value and/or a fine conversion value, where coarse conversion values correspond to fewer conversion operations and lower anonymity and the fine conversion values correspond to more conversion operations and higher anonymity.

At block 808, the reporting data structure may be transmitted to the advertisement network server (e.g., the advertisement network server 104). The reporting data structure may be transmitted via a network (e.g., the network 108). The reporting data structure may be sent to the advertisement network server directly or indirectly. The advertisement network server may identify one or more data categories from a list of predefined data categories based on the selected sub-identifier and update one or more metrics (e.g., counters) associated with the identified data categories.

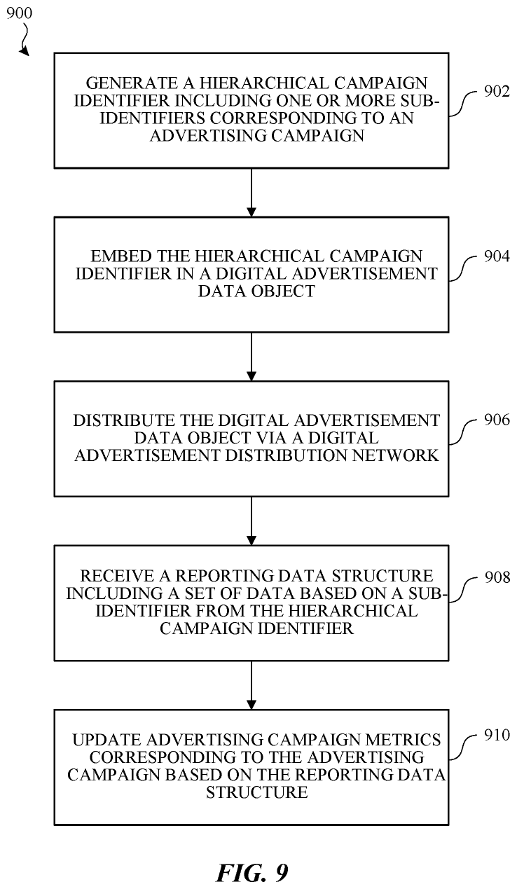

FIG. 9 depicts a flow diagram of an example process 900 for requesting advertisement campaign metrics by an advertisement network server, in accordance with one or more implementations. For explanatory purposes, the process 900 is primarily described herein with reference to the electronic device 102, the advertisement network server 104, and the aggregation server 106 of FIGS. 1 and 4. However, the process 900 is not limited to the electronic device 102, the advertisement network server 104, and/or the aggregation server 106, and one or more blocks (also referred to as operations) of the process 900 may be performed by one or more other components of the advertisement network server 104, and/or by other suitable devices. Further, for explanatory purposes, the blocks of the process 900 are described herein as occurring sequentially or linearly. However, multiple blocks of the process 900 may occur in parallel. In addition, the blocks of the process 900 need not be performed in the order shown and/or one or more blocks of the process 900 need not be performed and/or can be replaced by other operations.

At block 902, a hierarchical campaign identifier (e.g., hierarchical campaign identifier 512) is generated by an advertisement network server (e.g., the advertisement network server 104). The hierarchical campaign identifier may correspond to an advertisement campaign and include one or more sub-identifiers for receiving data at various levels of granularity. For example, a hierarchical campaign identifier may include one or more tiers of sub-identifiers, each tier increasing in granularity (e.g., 0-99, 0-999, and 0-9999). The increase in granularity in each tier allows developers to have more sub-identifiers to correlate more combinations of data categories, and thus receive more granular data if anonymity allows. Generating the hierarchical campaign identifier may include selecting a sub-identifier from each tier so that the advertisement network server can process metrics corresponding to the most granular sub-identifier, if anonymity permits, or fall back on one of the less granular sub-identifiers in cases of lower levels of anonymity.

At block 904, the hierarchical campaign identifier may be embedded in a digital advertisement data object. A digital advertisement data object may include an advertisement signature (e.g., the advertisement signature 302). The digital advertisement data object may be an advertisement (e.g., the advertisement 304) for a first application that can be purchased and/or downloaded from an application store. The digital advertisement data object may be associated with a second application (e.g., the second application 410) installed on an electronic device (e.g., the electronic device 102).

At block 906, the digital advertisement data object (e.g., the advertisement 304) may be distributed via a content delivery network, such as a digital advertisement distribution network (e.g., run by advertisement network server 104). The content delivery network can facilitate the delivery of an advertisement campaign. Connections to the advertisement network server (e.g., the advertisement network server 104) can be established directly or indirectly (e.g., via a proxy server). The advertisement network server can deliver the advertisement (e.g., the advertisement 304) with the advertisement signature (e.g., the advertisement signature 302) to an electronic device (e.g., the electronic device 102). The electronic device can execute a second application (e.g., the second application 410) that is registered with the advertisement network server to display advertisements inside the application. An advertisement for the first application can be displayed via a UI of the second application. When a user taps the advertisement for the first application (e.g., the first application 420) that is displayed in the second application, the application identifier included in the advertisement enables a UI for the application store (e.g., application store 310) to be loaded. The UI for the application store can include a UI element that enables the purchase and/or download of the first application.

At block 908, a reporting data structure (e.g., the reporting data structure 316) may be received from at least one campaign client module (e.g., campaign client module 208) via the advertisement distribution network. The reporting data structure may correspond to an advertisement for a first application (e.g., the first application 420) presented in association with a second application (e.g., the second application 410). Accordingly, the reporting data structure may include an application identifier corresponding to the first application and/or the second application, based on the anonymity data.

The reporting data structure may also include a set of data based on the selected sub-identifier. The set of data may include the sub-identifier from the hierarchical campaign identifier selected based on an anonymity function processed by the aggregation server. The set of data may also include a conversion value of a conversion operation associated with an application (e.g., the first application 420). The conversion operation may be an operation from a list of predefined operations associated with one or more conversion values, as defined by the developer of the application. The one or more conversion values may be a coarse conversion value and/or a fine conversion value, where coarse conversion values correspond to fewer conversion operations and lower anonymity and the fine conversion values correspond to more conversion operations and higher anonymity.

At block 910, the advertisement campaign metrics corresponding to the advertisement campaign are updated based on the reporting data structure (e.g., the reporting data structure 316). The advertisement network server (e.g., the advertisement network server 104) may maintain a set of advertisement campaign metrics to measure the performance of an advertisement campaign. The advertisement campaign metrics may relate to values associated with predefined data categories. The one or more of the data categories may correspond to the sub-identifier included in a reporting data structure from one or more associated devices (e.g., the electronic device 102). The advertisement network server 104 may extract the set of data from the reporting data structure and provide the set of data to at least one process, such as a data analytics process that updates metrics associated with the data categories and/or values associated therewith based on the received sub-identifier. For example, the data analytics process may maintain a counter of the number of sub-identifiers received for a set of data categories and/or values associated therewith and increment the counter as a sub-identifier corresponding to the set of data categories and/or values associated therewith is received.

As described above, one aspect of the present technology is the gathering and use of data available from specific and legitimate sources for data sharing for campaigns using hierarchical campaign identifiers. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for data sharing for campaigns using hierarchical campaign identifiers. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of the present disclosure, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

FIG. 10 depicts an example electronic system 1000 with which aspects of the present disclosure may be implemented. The electronic system 1000 can be, and/or can be a part of, any electronic device for generating the features and processes described in reference to FIGS. 1-9, including but not limited to a laptop computer, tablet computer, smartphone, and wearable device (e.g., smartwatch, fitness band). The electronic system 1000 may include various types of computer-readable media and interfaces for various other types of computer-readable media. The electronic system 1000 includes one or more processing unit(s) 1012, a persistent storage device 1002, a system memory 1004 (and/or buffer), an input device interface 1014, an output device interface 1006, a bus 1008, a ROM 1010, one or more processing unit(s) 1012, one or more network interface(s) 1016, and/or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the persistent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The persistent storage device 1002, on the other hand, may be a read-and-write memory device. The persistent storage device 1002 may be a non-volatile memory unit that stores instructions and data even when the electronic system 1000 is off. In one or more implementations, a mass-storage device (such as a magnetic or optical disk and its corresponding disk drive) may be used as the persistent storage device 1002.

In one or more implementations, a removable storage device (such as a floppy disk, flash drive, and its corresponding disk drive) may be used as the persistent storage device 1002. Like the persistent storage device 1002, the system memory 1004 may be a read-and-write memory device. However, unlike the persistent storage device 1002, the system memory 1004 may be a volatile read-and-write memory, such as RAM. The system memory 1004 may store any of the instructions and data that one or more processing unit(s) 1012 may need at runtime. In one or more implementations, the processes of the subject disclosure are stored in the system memory 1004, the persistent storage device 1002, and/or the ROM 1010. From these various memory units, the one or more processing unit(s) 1012 retrieves instructions to execute and data to process in order to execute the processes of one or more implementations.

The bus 1008 also connects to the input device interfaces 1014 and output device interfaces 1006. The input device interface 1014 enables a user to communicate information and select commands to the electronic system 1000. Input devices that may be used with the input device interface 1014 may include, for example, alphanumeric keyboards, touch screens, and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes through the one or more network interface(s) 1016. In this manner, the electronic system 1000 can be a part of a network of computers (such as a LAN, a wide area network (“WAN”), an Intranet, or a network of networks, such as the Internet). Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, by a campaign client module and via an advertisement network server, a hierarchical campaign identifier including one or more sub-identifiers;
accessing, by the campaign client module and from an aggregation server, anonymity data;
selecting a sub-identifier from the one or more sub-identifiers of the hierarchical campaign identifier based on the anonymity data;
generating a reporting data structure including a set of data based on the sub-identifier; and
transmitting the reporting data structure to the advertisement network server.

2. The method of claim 1, wherein the set of data includes a conversion value of a conversion operation associated with an application.

3. The method of claim 2, wherein the conversion operation is an operation from a list of predefined operations associated with the application and is associated with one or more conversion values.

4. The method of claim 3, wherein the one or more conversion values include at least one of a coarse conversion value and a fine conversion value.

5. The method of claim 1, wherein the set of data includes the selected sub-identifier.

6. The method of claim 1, wherein the selected sub-identifier corresponds to one or more data categories from a list of predefined data categories.

7. The method of claim 1, wherein the reporting data structure corresponds to an advertisement for a first application, the advertisement being presented in association with a second application.

8. The method of claim 7, wherein the reporting data structure further includes an application identifier corresponding to at least one of the first application and the second application based on the anonymity data.

9. The method of claim 1, wherein the anonymity data is based on anonymity metrics of a plurality of devices associated with the aggregation server and an application.

10. The method of claim 1, wherein selecting the sub-identifier comprises:
identifying one or more anonymity thresholds corresponding to the one or more sub-identifiers, wherein each respective anonymity threshold corresponds to a respective sub-identifier of the one or more sub-identifiers;
determining whether the anonymity data indicates anonymity exceeding one or more of the one or more anonymity thresholds; and
selecting the sub-identifier corresponding to the most data and exceeding an anonymity threshold.

11. The method of claim 1, wherein the hierarchical campaign identifier is received in response to at least one of a request to purchase, redownload, or install a first application subsequent to presentation of an advertisement in association with a second application.

12. A non-transitory computer-readable medium comprising computer-readable instructions that, when executed by a processor, cause the processor to perform one or more operations comprising:
receiving, by a campaign client module and via an advertisement network server, a hierarchical campaign identifier including one or more sub-identifiers;
accessing, by the campaign client module and from an aggregation server, anonymity data;
selecting a sub-identifier from the one or more sub-identifiers of the hierarchical campaign identifier based on the anonymity data;
generating a reporting data structure including a set of data based on the sub-identifier; and
transmitting the reporting data structure to the advertisement network server.

13. The non-transitory computer-readable medium of claim 12, wherein the set of data includes a conversion value of a conversion operation associated with an application.

14. The non-transitory computer-readable medium of claim 13, wherein the conversion operation is an operation from a list of predefined operations associated with the application and is associated with one or more conversion values, and wherein the one or more conversion values include at least one of a coarse conversion value and a fine conversion value.

15. The non-transitory computer-readable medium of claim 12, wherein the set of data includes the selected sub-identifier.

16. The non-transitory computer-readable medium of claim 12, wherein selecting the sub-identifier comprises:
identifying one or more anonymity thresholds corresponding to the one or more sub-identifiers, wherein each respective anonymity threshold corresponds to a respective sub-identifier of the one or more sub-identifiers;
determining whether the anonymity data indicates anonymity exceeding one or more of the one or more anonymity thresholds; and
selecting the sub-identifier corresponding to the most data and exceeding an anonymity threshold.

17. A device comprising:
a processor; and
a memory storing instructions that, when executed by the processor, cause the processor to perform operations comprising:
receiving, via an advertisement network server, a hierarchical campaign identifier including one or more sub-identifiers;
accessing, from an aggregation server, anonymity data;
selecting a sub-identifier from the one or more sub-identifiers of the hierarchical campaign identifier based on the anonymity data;
generating a reporting data structure including a set of data based on the sub-identifier; and
transmitting the reporting data structure to the advertisement network server.

18. The device of claim 17, wherein the set of data includes a conversion value of a conversion operation associated with an application and includes the selected sub-identifier.

19. The device of claim 18, wherein the conversion operation is an operation from a list of predefined operations associated with the application and is associated with one or more conversion values, and wherein the one or more conversion values include at least one of a coarse conversion value and a fine conversion value.

20. The device of claim 17, wherein selecting the sub-identifier comprises:
identifying one or more anonymity thresholds corresponding to the one or more sub-identifiers, wherein each respective anonymity threshold corresponds to a respective sub-identifier of the one or more sub-identifiers;
determining whether the anonymity data indicates anonymity exceeding one or more of the one or more anonymity thresholds; and
selecting the sub-identifier corresponding to the most data and exceeding an anonymity threshold.
